(19) United States
(12) Patent Application Publication
(10) Pub. No.: US 2007/0205214 A1
(43) Pub. Date: Sep. 6, 2007

(54) Liquid dispense system

(76) Inventor: Benjamin R. Roberts, Los Altos, CA (US)

Correspondence Address: THE BOC GROUP, INC., 575 MOUNTAIN AVENUE, MURRAY HILL, NJ, 07974-2064, US

(21) Appl. No.: 11/368,288

(22) Filed: Mar. 3, 2006

(51) Int. Cl. B67D 5/08; B65D 88/54

(52) U.S. Cl. 222/58; 222/318; 222/109

(57) ABSTRACT

The present invention provides a system, apparatus and method for supplying liquid through a dispensing loop to tools requiring such liquid. In particular, the present invention provides a system, apparatus and method for supplying liquid or slurry to CMP (chemical mechanical polishing) tools of a semiconductor manufacturing process. In accordance with the present invention, the liquid is delivered at a consistent flow rate and pressure to the tools, by controlling the flow rate and pressure through the use of pumps combined with flow or pressure sensors in the dispense loop.

### BACKGROUND OF THE INVENTION

The present invention provides a system, apparatus and method for supplying a liquid through a dispensing loop to tools requiring such liquid. In particular, the present invention provides a system, apparatus and method for supplying liquid to CMP (chemical mechanical polishing) tools of a semiconductor manufacturing process.

Liquids, including slurries are used in a variety of surface treatment techniques, particularly in the manufacture of semiconductor devices. An important aspect of the use of such liquids is the control of the flow and pressure to the semiconductor manufacturing tools. By maintaining constancy of the flow and pressure, greater stability of the tool process can be achieved. Further, by controlling the flow and pressure, damage from shear forces that produce agglomerations that destroy the usefulness and effectiveness of the liquid, can be reduced.

U.S. Pat. No. 6,019,250, commonly assigned with the present invention, describes a system and method for dispensing liquid through a flow circuit to points of use. In particular, this system and method require a plurality (preferably three) chambers, each having a dispense, return and fill modes of operation. The method and apparatus described includes a regulation means for regulating pressure in each of the chambers so that liquid pressure at each point of use remains substantially constant.

Moreover, there is a need in the art to reduce the complexity of liquid delivery systems by reducing the number of vessels and connection apparatus needed. This in turn helps in reducing the cost of such systems and the overall semiconductor manufacturing costs.

### SUMMARY OF THE PRESENT INVENTION

The present invention provides a system, apparatus and method for supplying liquid through a dispensing loop to tools requiring such liquid, wherein the liquid is delivered at a consistent flow rate and pressure to the tools. In accordance with the present invention, the flow rate and pressure are controlled using positive displacement pumps or centrifugal pumps combined with flow or pressure sensors in the dispense loop.

The details of the system, apparatus and methods of the present invention will be described in detail below with reference to the following drawing figures.

### BRIEF DESCRIPTION OF THE DRAWINGS

FIG. 1 is a schematic view of a system in accordance with a first embodiment of the present invention.

FIG. 2 is a schematic view of a system in accordance with a second embodiment of the present invention.

### DETAILED DESCRIPTION OF THE INVENTION

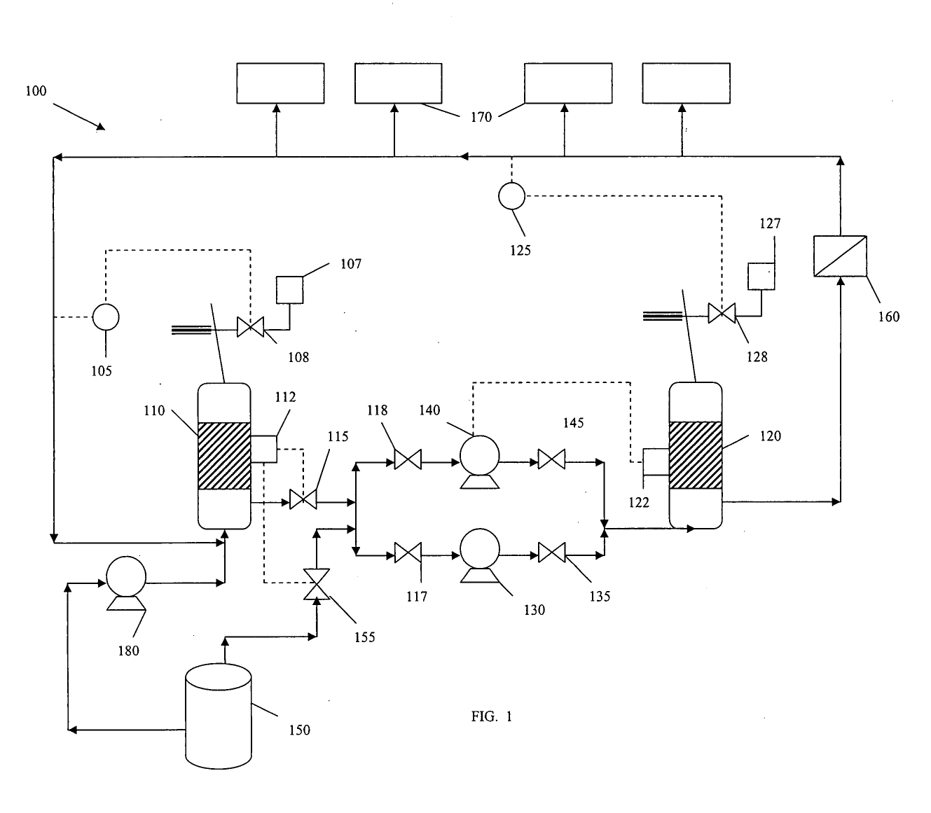

FIG. 1 is a schematic view of a system in accordance with a first embodiment of the present invention. In particular, FIG. 1 shows a liquid dispensing system 100 comprising a return vessel 110 and a dispense vessel 120, wherein the pressure and flow control is managed using positive displacement pumps, such as those numbered 130 and 140. In most instances, the pumps 130 and 140 are redundant, i.e. one pump acts as a back up to the other, but it is also possible to operate pump 130 independently from pump 140 as will be discussed in more detail further below. In either case, the pumps 130 and 140 do not provide direct control of the pressure or flow, but rather take liquid from either the return vessel 110 or day tank 150 and deliver such liquid at a higher pressure to the dispense vessel 120. In this embodiment the return vessel 110 and dispense vessel 120 do not cycle (fill and empty) during operation. The operating sequence for this embodiment of the present invention is more fully described below.

Initially, liquid is drawn into the dispense vessel 120 from a source drum or day tank 150 until the liquid level in dispense vessel 120 is at a predetermined high set point. Dispense vessel 120 is then pressurized and dispensing of the liquid begins, while the level of liquid in dispense vessel 120 is maintained within a predetermined range by drawing additional liquid from the day tank 150. In particular, a level sensor 122 is used to sense the level of liquid within dispense vessel 120 and to turn the pump on or off. For example, if pump 130 is being used, the pump 130 is turned on when the liquid level falls to a predetermined low set point and liquid is drawn from day tank 150, and the pump 130 is turned off when the liquid level reaches a predetermined high set point and no further liquid is drawn from day tank 150. The liquid continues through the dispensing system and optionally passes through a filter 160 before delivery to tools 170. Liquid that is not delivered to tools 170 continues through the dispensing system and flows into the return vessel 110 until the level of liquid in the return vessel 110 reaches a predetermined high set point. Once the liquid level in return vessel 110 has reached the high set point, liquid may be drawn from the return vessel 110 and delivered to the dispense vessel 120. When the liquid level in the return vessel 110 is below a predetermined low set point, additional liquid is drawn from day tank 150 into dispense tank 120. By controlling the state, i.e. on or off, of the operating pump; and liquid source, i.e. day tank 150 or return vessel 110; the appropriate levels of liquid in both dispense vessel 120 and return vessel 110 can be maintained.

The method of the present invention can be further explained by reference to a valve operation sequence. In particular, upon initial operation, valve 155 would be opened so that liquid is transported from the day tank 150 to dispense vessel 120 using the operating pump. Valves 117 and 135 are primarily provided to allow isolation of the pump 130 in the case of needed repair or servicing and to assure that liquid does not flow back into the pump and therefore may remain open during operation. Similarly, valves 118 and 145 are primarily provided to allow isolation of the pump 140 in the case of needed repair or servicing and may be simple check valves to assure that liquid does not flow back into the pump and therefore may remain open during operation. Once the predetermined high set point is reached, the level sensor 122 signals the operating pump to turn off and dispense vessel 120 is pressurized using N2 feed 127 and associated valve 128 and dispensing of liquid begins. The valve 155 is preferably closed at this time so that further liquid is not drawn from day tank 150. When the level sensor 122 senses that the liquid level in dispense vessel 120 falls to a predetermined low set point, the operating pump is turned on and valve 155 is re-opened so that further liquid is drawn from day tank 150. In this way the liquid level in dispense vessel 120 is maintained within a predetermined range. Liquid is delivered to the tools 170 and excess liquid flows into return vessel 110 until a predetermined high set point is reached. At this time, liquid may be delivered to the dispense vessel 120 from the return vessel 110 by opening valve 115. In particular, when level sensor 122 senses that the liquid level in dispense vessel 120 falls to the predetermined low set point, then a signal is sent to turn the operating pump on and valve 115 is opened so that liquid is drawn from return vessel 110 to dispense vessel 120. Drawing liquid from the return vessel 110 will reduce the liquid level therein until such time as a predetermined low set point is reached. At that time, valve 115 is closed and valve 155 is re-opened so that further liquid is drawn from day tank 150. In this manner, the liquid level in return tank 110 can be maintained within a predetermined range. A level sensor 112 is used to sense the liquid level in return vessel 110 and to control valves 115 and 155.

The flow rate and pressure of liquid through the system is maintained at a steady and constant rate at the entrance to the tools 170 by controlling the pressure in dispense tank 120 and return tank 110. In this embodiment, the pressure of dispense tank is controlled by the use of a pressure sensor 125 connected to the N2 feed 127 for the dispense vessel 120. By controlling the pressure in this manner, the dispense vessel acts as a pulse dampener and therefore no pulse dampener is needed for the operating pump, further reducing cost and complexity of the system. The pressure of the return vessel 110 is similarly controlled by use of a flow sensor 105 connected to the N2 feed 107 and associated valve 108 for the return vessel 110. In this manner the backpressure caused by return vessel 110 controls the flow rate through the system.

As noted above, the operating pump and the valves 115 and 155 act in concert to keep the liquid levels in dispense vessel 120 and return vessel 110 within predetermined levels. The liquid level in dispense vessel 120 is the primary parameter used to control the system. In particular, the operating pump is turned on and off depending on the level of liquid in the dispense vessel 120 as sensed by level sensor 122. The liquid level in return vessel 110 is the secondary parameter used to control the system. In particular, the valves 115 and 155 are opened or closed depending on the level of liquid in the return vessel 110 as sensed by level sensor 112.

The above operation is summarized in a general fashion in the following Table 1 showing the condition of the operating pump and valves for various states of the system depicted in FIG. 1. Other operation states could be used and the sequence shown in Table 1 is not intended to limit the present invention in any way.

TABLE 1

| | Operating | | |
|---|---|---|---|
| State | Pump | Valve 115 | Valve 155 |
| State One | On | Closed | Open |
| State Two | Off | Closed | Closed |
| State Three | On | Closed | Open |
| State Four | On | Open | Closed |

State One - fill dispense vessel from day tank with no dispensing
State Two - dispense liquid from dispense vessel with no fill taking place
State Three - dispense liquid from dispense vessel with fill from day tank
State Four - dispense liquid from dispense vessel with fill from return vessel

With reference to Table 1, the system of the present invention, according to the present embodiment may operate in any one of four states. In particular, the system begins operation in State One which continues until such time as the predetermined high set point is reached in the dispense vessel. Thereafter, the system cycles between operation in one of State Two, State Three or State Four, depending on the liquid levels within the dispense vessel and return vessel. In particular, as long as the liquid level in the dispense vessel is between the predetermined high set point and predetermined low set point, the system operates in State Two and no further liquid is drawn from either the day tank or return vessel. Once the liquid level in the dispense vessel reaches the predetermined low set point, then the system operates in either State Three or State Four depending on the liquid level with the return vessel. In particular, as long as the liquid level in the return vessel is between the predetermined high set point and predetermined low set point, the system operates in State Three and further liquid is drawn from the return vessel. If the liquid level in the return vessel is at or below the predetermined low set point, then the system operates in State Four and further liquid is drawn from the day tank.

There are several alternatives for the arrangement and components of the system according to the present invention as well as for the method of operation according to the present invention. For example, as noted above, the two pumps shown in FIG. 1 provide for redundancy and back up. Alternatively, a single pump or more than two pumps could be utilized. Moreover, two or more pumps could operate independently, e.g. one pump drawing liquid from the day tank and a second pump drawing liquid from the return vessel.

The pumps (whether one or a plurality) may be of any type normally used for liquid dispensing, such as the positive displacement pumps shown in FIG. 1, centrifugal pumps, impeller pumps, etc. In a further alternative, an adjustably speed pump could be utilized so that a constant level of liquid could be maintained in the dispense vessel. In this way, greater consistency of the pressure of the dispensed liquid to the tools can be achieved.

Further, the day tank shown in FIG. 1 is a gravity dispensing tank from which liquid is drawn using a pump. Alternatively, a day tank could be coupled directly to the return tank or the dispense tank and could be a gravity dispensing tank requiring a pump 180 for delivery of liquid to the return tank. In another alternative, the day tank could be a pressurized tank which would not require a pump for delivery to the connected tank.

As noted above, there are several check valves provided for pump isolation and to prevent backup of liquid into the pumps. In another alternative according to the present invention, these valves could be active valves and be controlled similarly to the valves 115 and 155 of FIG. 1.

FIG. 1 shows an arrangement wherein two valves are controlled by the sensed level of liquid within the return tank to determine whether liquid should be drawn from the return vessel or the day tank. As noted above, normally, only one of the valves would be open at any given time. In a further embodiment of the present invention, the two valves could be proportional valves allowing simultaneous drawing of liquid from the return vessel and the day tank.

The level sensors used in the present invention may be of any known type that sense the liquid level in the vessels, such as a load cell, an optical sensor, a capacitance sensor, a float sensor or a radar sensor. Further, the flow sensor 105 could be replaced with a pressure sensor to control the flow rate through the system.

While there are several similarities between the apparatus and method according to the present invention and that of U.S. Pat. No. 6,019,250 mentioned above, there are also significant differences. In particular, as noted, the prior art system and method requires a plurality of chambers, each having a dispense mode, a return mode and a fill mode of operation. In the present invention, there is a single dispense vessel having a dispense mode and fill mode of operation, that also allows for both dispense and fill modes to be ongoing simultaneously. The present system and method also includes a single return vessel, having return and delivery modes of operation, again that can be ongoing simultaneously. The present invention provides several advantages, including, reducing the overall equipment requirements for the system, simplification of the control operation, and reduction of maintenance requirements. All of these advantages result or help in reducing the overall cost of the system and operation thereof.

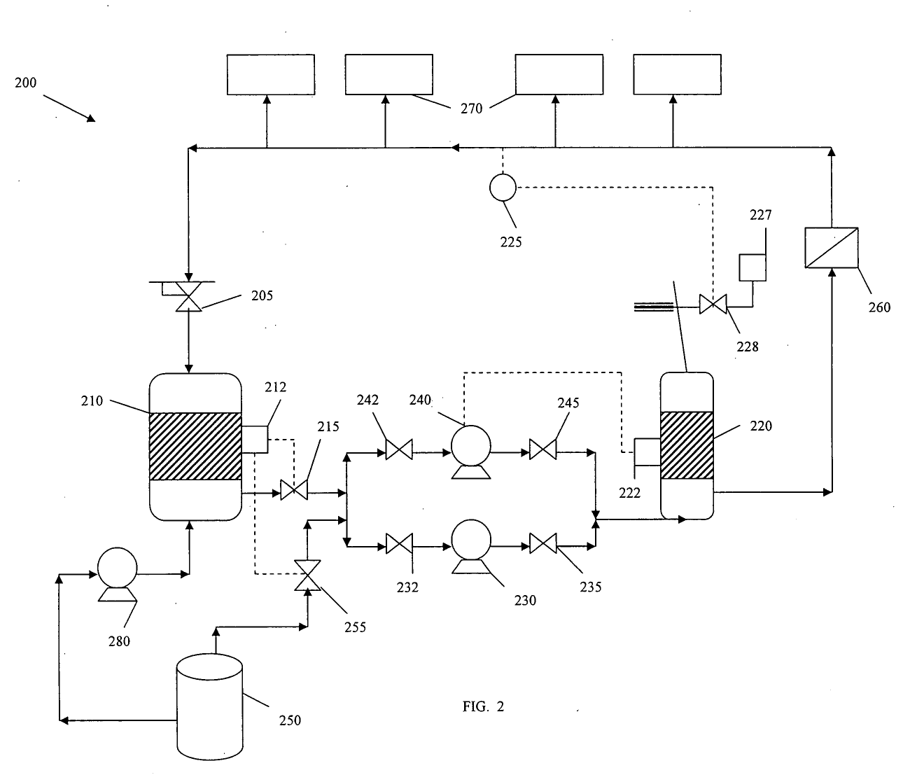

FIG. 2 is a schematic view of a system in accordance with a second embodiment of the present invention. In particular, FIG. 2 shows a liquid dispensing system 200 comprising a day tank 210 and a dispense vessel 220, wherein the pressure and flow control is managed using positive displacement pumps 230 and 240. Pressure control is achieved by managing the pressure in dispense vessel 220 and return flow is controlled by adjusting a valve orifice 205 for day tank 210. Once again, the pumps 230 and 240 do not provide direct control of the pressure or flow, but rather take liquid from the day tank 210 and deliver such liquid at a higher pressure to the dispense vessel 220. The operating sequence for this embodiment of the present invention is more fully described below.

Initially, liquid is drawn into the dispense vessel 220 from a source drum or blend system 250 until the liquid level in dispense vessel 220 is at a predetermined high set point. Dispense vessel 220 is then pressurized using N2 feed 227 and associated valve 228 and dispensing of the liquid begins, while the level of liquid in dispense vessel 220 is maintained within a predetermined range by drawing additional liquid from the source drum 250. In particular, a level sensor 222 is used to sense the level of liquid within dispense vessel 220 and to turn the operating pump on or off. For example, if pump 230 is being used, the pump 230 is turned on when the liquid level falls to a predetermined low set point and liquid is drawn from source drum 250, and the pump 230 is turned off when the liquid level reaches a predetermined high set point and no further liquid is drawn from source drum 250. The liquid continues through the dispensing system and optionally passes through a filter 260 before delivery to tools 270. Liquid that is not delivered to tools 270 continues through the dispensing system and flows into the day tank 210 until the level of liquid in the day tank 210 reaches a predetermined high set point. Once the liquid level in day tank 210 has reached the high set point, liquid may be drawn from the day tank 210 and delivered to the dispense vessel 220. When the liquid level in the day tank 210 is below a predetermined low set point, additional liquid is drawn from source drum 250 into dispense tank 220. By controlling the state, i.e. on or off, of the operating pump; and liquid source, i.e. source drum 250 or day tank 210; the appropriate levels of liquid in both dispense vessel 220 and day tank 210 can be maintained.

The method of the present invention can be further explained by reference to a valve operation sequence for the embodiment shown in FIG. 2. In particular, upon initial operation, valve 255 would be opened so that liquid is transported from the source drum 250 to dispense vessel 220 using the operating pump. Valves 232 and 235 are primarily provided to allow isolation of the pump 230 in the case of needed repair or servicing and to assure that liquid does not flow back into the pump and therefore may remain open during operation. Similarly, valves 242 and 245 are primarily provided to allow isolation of the pump 240 in the case of needed repair or servicing and may be simple check valves to assure that liquid does not flow back into the pump and therefore may remain open during operation. Once the predetermined high set point is reached in dispense vessel 220, the level sensor 222 signals the operating pump to turn off and dispense vessel 220 is pressurized using N2 feed 227 and associated valve 228 and dispensing of liquid begins. The valve 255 is preferably closed at this time so that further liquid is not drawn from source drum 250. When the level sensor 222 senses that the liquid level in dispense vessel 220 falls to a predetermined low set point, the operating pump is turned on and valve 255 is re-opened so that further liquid is drawn from source drum 250. In this way the liquid level in dispense vessel 220 is maintained within a predetermined range. Liquid is delivered to the tools 270 and excess liquid flows into day tank 210 until a predetermined high set point is reached. At this time, liquid may be delivered to the dispense vessel 220 from the day tank 210 by opening valve 215. In particular, when level sensor 222 senses that the liquid level in dispense vessel 220 falls to the predetermined low set point, then a signal is sent to turn the operating pump on and valve 215 is opened so that liquid is drawn from day tank 210 to dispense vessel 220. Drawing liquid from the day tank 210 will reduce the liquid level therein until such time as a predetermined low set point is reached. At that time, valve 215 is closed and valve 255 is re-opened so that further liquid is drawn from source drum 250. In this manner, the liquid level in day tank 210 can be maintained within a predetermined range. A level sensor 212 is used to sense the liquid level in day tank 210 and to control valves 215 and 255.

The flow rate and pressure of liquid through the system is maintained at a steady and constant rate at the entrance to the tools 270 by controlling the pressure in dispense tank 220 and day tank 210. In this embodiment, the pressure of dispense tank is controlled by the use of a pressure sensor 225 connected to the N2 feed 227 for the dispense vessel 220. By controlling the pressure in this manner, the dispense vessel acts as a pulse dampener and therefore no pulse dampener is needed for the operating pump, further reducing cost and complexity of the system. The pressure of the day tank 210 is similarly controlled by use of a valve orifice 205 or similar flow control device for the day tank 210. In this manner the flow rate through the system can be controlled.

The operating pump and the valves 215 and 255 act in concert to keep the liquid levels in dispense vessel 220 and day tank 210 within predetermined levels. The liquid level in dispense vessel 220 is the primary parameter used to control the system. In particular, the operating pump is turned on and off depending on the level of liquid in the dispense vessel 220 as sensed by level sensor 222. The liquid level in day tank 210 is the secondary parameter used to control the system. In particular, the valves 215 and 255 are opened or closed depending on the level of liquid in the day tank 210 as sensed by level sensor 212.

The above operation is summarized in a general fashion in the following Table 2 showing the condition of the operating pump and operational valves for various states of the system depicted in FIG. 2. Other operation states could be used and the sequence shown in Table 2 is not intended to limit the present invention in any way.

TABLE 2

| | Operating | | |
|---|---|---|---|
| State | Pump | Valve 215 | Valve 255 |
| State One | On | Closed | Open |
| State Two | Off | Closed | Closed |
| State Three | On | Closed | Open |
| State Four | On | Open | Closed |

State One - fill dispense vessel from source drum tank with no dispensing
State Two - dispense liquid from dispense vessel with no fill taking place
State Three - dispense liquid from dispense vessel with fill from source drum
State Four - dispense liquid from dispense vessel with fill from day tank

With reference to Table 2, the system of the present invention, according to the present embodiment may operate in any one of four states. In particular, the system begins operation in State One which continues until such time as the predetermined high set point is reached in the dispense vessel. Thereafter, the system cycles between operation in one of State Two, State Three or State Four, depending on the liquid levels within the dispense vessel and day tank. In particular, as long as the liquid level in the dispense vessel is between the predetermined high set point and predetermined low set point, the system operates in State Two and no further liquid is drawn from either the source drum or day tank. Once the liquid level in the dispense vessel reaches the predetermined low set point, then the system operates in either State Three or State Four depending on the liquid level within the day tank. In particular, as long as the liquid level in the day tank is between the predetermined high set point and predetermined low set point, the system operates in State Three and further liquid is drawn from the day tank. If the liquid level in the return vessel is at or below the predetermined low set point, then the system operates in State Four and further liquid is drawn from the source drum.

All of the alternatives noted above with respect to the embodiment shown in FIG. 1 would be equally applicable to the embodiment shown in FIG. 2. For example, a single pump or multiple pumps operating redundantly or independently may be used. Further, the pumps may be of any type normally used for liquid dispensing, including an adjustable speed pump. Moreover, the source drum could be a gravity dispensing tank requiring a pump 280 or a pressurized tank and could be coupled directly to the return tank or the dispense tank. In addition, different types of valves may be used and actively controlled and any known type of level sensor may be utilized.

The present invention as described above, provides a system, apparatus and method for supplying liquid through a dispensing loop to tools requiring such liquid. As previously noted, a particular embodiment relates to the delivery of slurry to CMP tools of a semiconductor manufacturing process. The present invention allows for delivery of the liquid or slurry at a constant flow rate and pressure, thus providing greater stability of the tool processes. In addition, damage from shear forces that produce agglomerations that destroy the usefulness and effectiveness of the liquid or slurry, can be reduced by using the system, apparatus and method of the present invention. Moreover, the present invention is relatively simple as compared to prior art delivery systems. In particular, the number of vessels and connection apparatus needed are reduced in the present invention which may result in a reduction of the cost of such systems and the overall semiconductor manufacturing costs.

It is anticipated that other embodiments and variations of the present invention will become readily apparent to the skilled artisan in the light of the foregoing description and examples, and it is intended that such embodiments and variations likewise be included within the scope of the invention as set out in the appended claims.

What is claimed is:

1. An apparatus for dispensing liquid to at least one point of use comprising:
a dispense vessel having a dispense mode of operation in which liquid is dispensed form the dispense vessel, and a fill mode of operation in which liquid is introduced to the dispense vessel;
a return vessel having a return mode of operation in which unused liquid is returned to the return vessel, and a delivery mode of operation in which liquid is delivered from the return vessel;
a liquid distribution system connecting the at least one point of use, the dispense vessel and the return vessel, to provide liquid from the dispense vessel to the at least one point of use, to return unused liquid to the return vessel, and to deliver liquid from the return vessel to the dispense vessel; and
control means to regulate flow of liquid through the liquid distribution system so that liquid flow at the at least one point of use is substantially constant.

2. An apparatus according to claim 1, further comprising first sensor means associated with the dispense vessel to measure the amount of liquid in the dispense vessel and second sensor means associated with the return vessel to measure the amount of liquid in the return vessel.

3. An apparatus according to claim 2, wherein the first sensor means and the second sensor means are the same or different and are selected from the group consisting of level sensors, load cells, optical sensors, capacitance sensors, float sensors and radar sensors.

4. An apparatus according to claim 1, wherein the liquid distribution system includes a liquid source for providing liquid to the dispense vessel or the return vessel or both.

5. An apparatus according to claim 4, wherein the liquid source is a day tank and the liquid distribution system further includes pump means to pump liquid into the dispense tank.

6. An apparatus according to claim 5, wherein the pump means comprises a positive displacement pump, a centrifugal pump, an impeller pump or an adjustable speed pump.

7. An apparatus according to claim 4, wherein the liquid source is a pressured tank.

8. An apparatus according to claim 1, wherein the liquid distribution system further includes means to control the flow rate of liquid to the at least one point of use within a predetermined range, wherein the control means is connected to a control device for the dispense vessel.

9. An apparatus according to claim 8, wherein the control means is a pressure sensor.

10. An apparatus according to claim 9, wherein the control device comprises a nitrogen gas source and a regulator.

11. An apparatus according to claim 8, wherein the control means comprises a flow meter.

12. An apparatus according to claim 8, wherein the control means is further connected to a control device for the return vessel.

13. An apparatus according to claim 12, wherein the control means for the return vessel is a nitrogen gas source and a regulator.

14. An apparatus according to claim 1, wherein the at least one point of use is a tool in a semiconductor fabrication process.

15. An apparatus according to claim 1, wherein the liquid is a slurry.

16. A method of dispensing liquid comprising:
filling a dispense vessel with liquid to a predetermined dispense high set point from a liquid source;
dispensing the liquid to at least one point of use in excess of the amount needed;
providing the excess liquid to a return vessel to a predetermined return high set point;
providing further liquid to the dispense vessel from at least one of the liquid source or the return vessel when the liquid level in the dispense vessel reaches a predetermined dispense low set point;
wherein the level of liquid in the dispense vessel in maintained between the predetermined dispense high set point and the predetermined dispense low set point and the level of liquid in the return vessel in maintained between the predetermined return high set point and a predetermined return low set point.

17. A method according to claim 16, wherein the at least one points of use is a tool in a semiconductor manufacturing process.

18. A method according to claim 16, wherein the liquid is a slurry.

19. A method of maintaining a constant rate of liquid flow to at least one point of use comprising:
providing liquid to the at least one point of use through a liquid distribution system;
measuring a characteristic of the liquid at a location near the at least one point of use; and
controlling the flow rate of the liquid through the liquid distribution system based on the measured characteristic.

20. A method according to claim 19, wherein the measured characteristic is pressure and wherein controlling the flow rate comprises controlling pressure in a liquid dispense vessel associated with the liquid distribution system.

21. A method according to claim 19, wherein the measured characteristic is flow rate and wherein controlling the flow rate comprises controlling pressure in a liquid dispense vessel associated with the liquid distribution system.

22. A method according to claim 19, where the at least one point of use is a tool in a semiconductor manufacturing process.

23. A method according to claim 19, wherein the liquid is a slurry.
